(19) United States
(12) Patent Application Publication
(10) Pub. No.: US 2015/0022482 A1
(43) Pub. Date: Jan. 22, 2015

(54) MULTI-TOUCH MANAGEMENT FOR TOUCH SCREEN DISPLAYS

(71) Applicant: International Business Machines Corporation, Armonk, NY (US)

(72) Inventors: Trudy L. Hewitt, Cary, NC (US); Francesco C. Schembari, Durham, NC (US); Christina L. Wetli, Raleigh, NC (US)

(21) Appl. No.: 13/946,978

(22) Filed: Jul. 19, 2013

(51) Int. Cl. G06F 3/0487

(52) U.S. Cl. CPC G06F 3/0487
USPC 345/174

(57) ABSTRACT

Embodiments of the present invention provide a method and device for processing multiple touches on a display of a touch screen device. In an embodiment of the invention, a method for processing multiple touches on a display of a touch screen device includes detecting a touch to a location of a touch screen display of a computing device. The method also includes determining (1) whether or not the detected touch has occurred within a pre-determined period of time from a previously detected touch to the touch screen display (2) at a location proximate to the location of the detected touch and (3) at a time when a refreshing of a user interface of the computing device lags beyond a threshold the detection of the touch. If so, the detected touch is disregarded.

### BACKGROUND OF THE INVENTION

1. Field of the Invention

The present invention relates to touch screen processing and more particularly to the processing of multiple touches on a display of a touch screen device.

2. Description of the Related Art

Touch screen devices are computing devices that provide, as a primary mode of user interface interaction, a touch screen through which an end user can input commands by tapping portions of the display screen with a finger or stylus. Touch screen devices can be constructed in many ways and can use several different technologies to detect the touch of a finger or stylus. For example, touch screen devices have been developed utilizing one or more of resistive, surface acoustic wave, capacitive, infrared, dispersive signal, pulse recognition and optical imaging technologies. Most common touch screen devices for portable computing applications utilize capacitive technologies.

A capacitive touch screen can be constructed so as to recognize one or more fingers touching a display, to interpret the command that this represents, and to communicate the command to the appropriate application. To construct a capacitive touch screen, four layers are required: a top polyester layer coated with a transparent metallic conductive coating on the bottom and adhesive spacer, a glass layer coated with a transparent metallic conductive coating on the top and an adhesive layer on the backside of the glass for mounting. In this way, when a user touches the surface, the system records the change in the electrical current that flows through the display.

Once a touch is registered in a touch screen, an event is passed to an event queue of the operating system and potentially to an event queue of an application for further processing. In response to detecting a tap event on a touch screen, an operation can be performed resulting in a change to a user interface for the application or operating system. However, the speed at which the event is processed and a change in the user interface directed can vary substantially from the speed in which the user interface refreshes depending upon the availability of processing resources in the underlying computing device.

When an end user applies a tap to the touch screen display of a computing device, it is expected that the user interface display refresh within a certain period of time so as to indicate the successful processing of the tap. When an unexpected delay in the refreshing of the user interface display occurs, the end user presumes that the tap had not been registered causing the end user to apply the same tap again. However, to the extent that the initial tap had been registered but no refreshing had yet to occur prior to the subsequent tap, intentionally, two separate taps will be registered and acted upon though it had been the intent of the end user to apply only a single tap.

### BRIEF SUMMARY OF THE INVENTION

Embodiments of the present invention address deficiencies of the art in respect to touch screen display management and provide a novel and non-obvious method and device for processing multiple touches on a display of a touch screen device. In an embodiment of the invention, a method for processing multiple touches on a display of a touch screen device includes detecting a touch to a location of a touch screen display of a computing device. The method also includes determining (1) whether or not the detected touch has occurred within a pre-determined period of time from a previously detected touch to the touch screen display (2) at a location proximate to the location of the detected touch and (3) at a time when a refreshing of a user interface of the computing device lags beyond a threshold the detection of the touch. If so, the detected touch is disregarded.

In one aspect of the embodiment, the refreshing of the user interface of the computing device is determined to lag beyond the threshold of the detection of the touch when it is determined that a refreshing of the user interface has not yet occurred subsequent to the detecting of the touch. In another aspect of the embodiment, the method additionally includes storing observed delays between detected touches by an end user of the computing device. Subsequently, it can be determined whether or not the detected touch has occurred within a pre-determined period of time from a previously detected touch to the touch screen display by determining whether or not the detected touch has occurred within a period of time not consistent with the stored observed delays.

In another embodiment of the invention, a computing device can be configured for processing multiple touches on a touch screen display. The device can include a housing enclosing a processor, memory and a touch screen display, a user interface rendered on the display and a multi-touch management module executing in the memory by the processor. The module can include program code enabled to detect a touch to a location of the touch screen display, to determine whether or not the detected touch has occurred within a pre-determined period of time from a previously detected touch to the touch screen display at a location proximate to the location of the detected touch and at a time when a refreshing of the user interface lags beyond a threshold of the detection of the touch, and to disregard the detected touch in response to determining that the detected touch has occurred within a pre-determined period of time from a previously detected touch to the touch screen display at a location proximate to the location of the detected touch and at a time when a refreshing of a user interface of the computing device lags beyond a threshold of the detection of the touch.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a device configured for processing of multiple touches on a display of a touch screen device; and,

FIG. 2 is a flow chart illustrating a process for processing of multiple touches on a display of a touch screen device.

### DETAILED DESCRIPTION OF THE INVENTION

Embodiments of the invention provide for processing of multiple touches on a display of a touch screen device. In accordance with an embodiment of the invention, a touch to a touch screen display of a computing device can detected and it can be determined whether or not the touch has occurred in a location proximate to a touch previously detected within a pre-determined period of time. If so, it can be determined whether or not a threshold delay exists between the detection of touches on the touch screen display and a refreshing of a user interface in the computing device. If so, the detected touch can be ignored as an unintended second touch occurring in consequence of the out of sync nature between the refreshing of the user interface and the recognition of the detected touch.

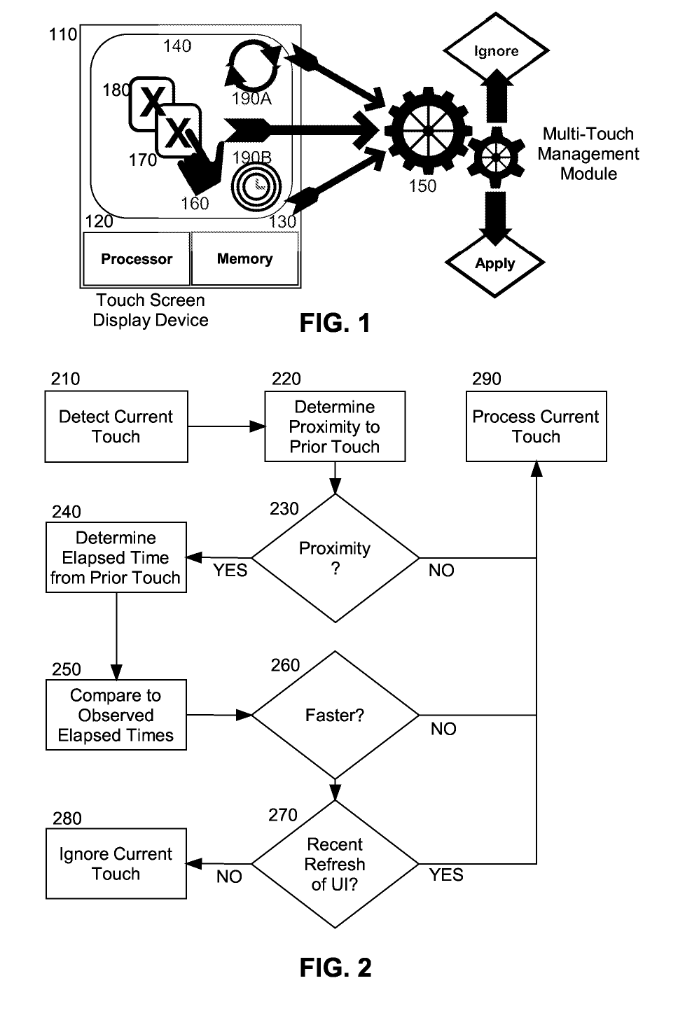

In further illustration, FIG. 1 is a pictorial illustration of a device configured for processing of multiple touches on a display of a touch screen device. As shown in FIG. 1, a device can be provided which includes a housing 110 incorporating a processor 120, memory 130 and a touch screen display 140. A multi-touch management module 150 further can be provided for execution in the memory 130 of the device by the processor 120 of the device. The module 150 can include program code that when executed in the memory 130 by the processor 120 of the device can detect a touch 160 of the touch screen display 140 at a current location 170 of the touch screen display 140.

In response to detecting the touch 170, the program code of the module 150 can determine whether the current location 170 is proximate to a prior location 180 of a previous touch of the touch screen display 140. Further, the program code of the module 150 can determine whether the detected touch 160 has occurred within a threshold period of time 190B since the previous touch. In this regard, the threshold period of time 190B can be user specified as a configuration of the module 150, the threshold period of time 190B can be programmatically established within the module 150, or the threshold period of time 190B can be dynamically determined based upon past observations of the passage of time between touches by an end user.

Of note, the program code of the module 150 can respond to a determination that the current location 170 of the detected touch 160 is proximate to a prior location 180 of a previous touch of the touch screen display 140 and further that the detected touch 160 has occurred within a threshold period of time 190B since the previous touch, by additionally determining whether or not a threshold delay 190A exists between the detection of the touch 160 and a refreshing of a user interface of the touch screen display 140. If a threshold delay 190A exists indicating that the processing of the detected touch 160 has outpaced the refreshing of the user interface, then the program code of the module 150 can direct the processor 120 to ignore the detected touch 160. Otherwise, the program code of the module 150 can process the detected touch 160.

In yet further illustration of the operation of the module 150, FIG. 2 is a flow chart illustrating a process for processing of multiple touches on a display of a touch screen device. Beginning in block 210, a touch can be detected in a touch screen display of the computing device. In block 220, a proximity to a prior detected touch can be determined, for example a touch at or very close to the prior detected touch in terms of coordinate distances from one location to another. In decision block 230, if the proximity is determined to be close as between the current and previous touch.

In block 240 an elapsed period of time between the current and previous touch can be determined and compared in block 250 to previously observed elapsed times. For example, the elapsed period of time can be compared to an average of previously elapsed times, a maximum previously elapsed time, or a minimum previously elapsed time to name a few examples. In decision block 260, if the elapsed period of time between the current and previous touch is considered to be faster than the previously observed elapsed times, then in decision block 270, it can be determined whether or not the user interface of the touch screen display has refreshed since the detection of the current touch. If not, the current touch can be ignored in block 280. Otherwise, in block 290 the current touch can be processed.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for processing multiple touches on a display of a touch screen device, the method comprising:
detecting a touch to a location of a touch screen display of a computing device;
determining whether or not the detected touch has occurred within a pre-determined period of time from a previously detected touch to the touch screen display at a location proximate to the location of the detected touch and at a time when a refreshing of a user interface of the computing device lags beyond a threshold the detection of the touch; and,
disregarding the detected touch in response to determining that the detected touch has occurred within a pre-determined period of time from a previously detected touch to the touch screen display at a location proximate to the location of the detected touch and at a time when a refreshing of a user interface of the computing device lags beyond a threshold the detection of the touch.

2. The method of claim 1, wherein the refreshing of the user interface of the computing device is determined to lag beyond the threshold of the detection of the touch when it is determined that a refreshing of the user interface has not yet occurred subsequent to the detecting of the touch.

3. The method of claim 1, further comprising:
storing observed delays between detected touches by an end user of the computing device; and,
determining whether or not the detected touch has occurred within a pre-determined period of time from a previously detected touch to the touch screen display by determining whether or not the detected touch has occurred within a period of time not consistent with the stored observed delays.

4. A computing device configured for processing multiple touches on a touch screen display, the device comprising:
a housing enclosing a processor, memory and a touch screen display;
a user interface rendered on the display; and,
a multi-touch management module executing in the memory by the processor, the module comprising program code enabled to detect a touch to a location of the touch screen display, to determine whether or not the detected touch has occurred within a pre-determined period of time from a previously detected touch to the touch screen display at a location proximate to the location of the detected touch and at a time when a refreshing of the user interface lags beyond a threshold of the detection of the touch, and to disregard the detected touch in response to determining that the detected touch has occurred within a pre-determined period of time from a previously detected touch to the touch screen display at a location proximate to the location of the detected touch and at a time when a refreshing of a user interface of the computing device lags beyond a threshold of the detection of the touch.

5. The device of claim 4, wherein the refreshing of the user interface of the computing device is determined to lag beyond the threshold of the detection of the touch when it is determined that a refreshing of the user interface has not yet occurred subsequent to the detecting of the touch.

6. The device of claim 5, wherein the program code of the module is further enabled to store observed delays between detected touches by an end user of the computing device and to determine whether or not the detected touch has occurred within a pre-determined period of time from a previously detected touch to the touch screen display by determining whether or not the detected touch has occurred within a period of time not consistent with the stored observed delays.
